(19) United States
(12) Patent Application Publication
(10) Pub. No.: US 2015/0035678 A1
(43) Pub. Date: Feb. 5, 2015

(54) SYSTEM AND METHOD FOR MONITORING A DISPENSER OF HAND HYGIENE PRODUCTS

(71) Applicant: Proventix Systems, Inc., Birmingham, AL (US)

(72) Inventor: Avery Dallas Long, Madison, AL (US)

(73) Assignee: Proventix Systems, Inc., Birmingham, AL (US)

(21) Appl. No.: 14/452,503

(22) Filed: Aug. 5, 2014

Related U.S. Application Data
(60) Provisional application No. 61/862,174, filed on Aug. 5, 2013.

(51) Int. Cl. G08B 21/24

(52) U.S. Cl. CPC G08B 21/245
USPC 340/573.1

(57) ABSTRACT

Embodiments of the present disclosure relate to a system and method for using a hand hygiene compliance (HHC) system to monitor compliance with hand hygiene protocols. More specifically, preferred embodiments of the HHC system include an electronic sensor configured to monitor use of a hand hygiene dispenser. The sensor preferably attaches to a lever on the hand hygiene dispenser and includes motion sensing devices such as, without limitation, gyroscopes and accelerometers. In preferred embodiments, motion sensing devise on the sensor detect motion of the lever when a person applies a force to the lever in order to cause the hand hygiene dispenser to dispense a hand hygiene product. Further, upon receiving data indicating motion of the lever, the hand hygiene compliance system correlates movement of the lever with an amount of hand hygiene product dispensed onto the person's hands.

### CROSS-REFERENCE TO RELATED APPLICATIONS

This application claims priority to U.S. Provisional Application for Patent Ser. No. 61/862,174 filed on Aug. 5, 2013, and entitled, “SYSTEM AND METHOD FOR MONITORING A DISPENSER OF HAND HYGIENE PRODUCTS,” the specification of which is incorporated herein by reference.

### TECHNICAL FIELD

The present disclosure relates to the use of an electronic sensor in conjunction with a hand hygiene compliance (HHC) system to monitor use of a dispenser of hand hygiene products, such as, but not limited to, a soap or hand sanitizer dispenser.

### BACKGROUND

The issue of healthcare-associated infections (HAIs) is well known within and outside the healthcare community. To date, many studies have been conducted in an effort to ascertain effective ways to reduce the occurrence of HAIs, and the clear majority finds a thorough cleansing of one's hands upon entering and exiting a patient's room as the single most effective way to prevent the spread of HAIs. As a result, in an attempt to improve patient care, many hospitals have installed HHC systems to monitor healthcare workers' compliance with hand hygiene protocols.

While state-of-the-art HHC systems can monitor healthcare workers' use of a hand hygiene dispenser, such systems currently lack the ability to accurately monitor the volume of soap or hand sanitizer product in a dispenser based upon use thereof. As an example, certain HHC systems use a mechanical switch to detect a hand hygiene event (that is, a person moving a lever on the dispenser to dispense a soap or hand sanitizer product). More specifically, these HHC systems determine whether or not a dispenser is running low or out of soap or hand sanitizer based upon the switch detecting a predefined number of hand hygiene events. However, the mechanical switch only detects hand hygiene events when a person moves the lever a predetermined amount, wherein the predetermined amount is an angle the lever must rotate through in order to trigger the switch. This provides an inaccurate representation of the volume of soap or hand sanitizer product in a dispenser, because it is possible to dispense soap or hand sanitizer without moving the lever the predetermined amount. As follows, since the mechanical switch only detects a limited number of hand hygiene events, the dispenser may, in some instances, run out of soap or hand sanitizer product before the mechanical switch detects the predefined number of hand hygiene events.

As such, due to the limitations of current HHC systems, environmental services workers must periodically check the level of soap or hand sanitizer for each dispenser in order to prevent one or more dispensers from becoming inoperable due to a lack of soap or hand sanitizer product. As follows, depending on the size of a facility and the number of dispensers located therein, this can become a rather burdensome task. Further, in order to check soap or hand sanitizer levels for a dispenser, environmental services workers must open or remove an enclosure that provides a housing for internal components of the dispenser, such as, without limitation, a reservoir (that is, a device configured to hold soap or hand sanitizer product and dispense said product each time the dispenser is used). Thus, in order to determine whether or not a dispenser is out of soap or hand sanitizer, environmental services workers must open or remove the enclosure and check the reservoir. Still further, on some dispensers, the enclosure includes a lock that prevents one from tapering with the internal components of the dispenser. Thus, in order to open the enclosure for such a dispenser, one must use a key manufactured by the vendor. Further, if a facility uses more than one vendor for dispensers that utilize the key and lock method, an already burdensome process becomes even more burdensome because, now environmental services worker must search for the appropriate key to use in order to unlock the enclosure. This process inherently consumes a significant amount of an environmental services' worker's time, which could be spent responding to more noteworthy tasks such as, without limitation, cleaning up a spill in a hallway or removing material from a patient's room.

As such, there is a need for systems and methods for automatically monitoring soap or hand sanitizer levels for a dispenser.

### SUMMARY

The present disclosure may address one or more of the problems and deficiencies discussed above. However, it is contemplated that the disclosure may prove useful in addressing other problems and deficiencies in a number of technical areas. Therefore, the present disclosure should not necessarily be construed as limited to addressing any of the particular problems or deficiencies discussed above.

Embodiments of the present disclosure provide systems and methods for monitoring use of a dispenser such as, without limitation, a hand hygiene dispenser. More specifically, systems and methods disclosed herein relate to the use of an electronic sensor in conjunction with a HHC system to monitor use of a dispenser, wherein the electronic sensor attaches to the dispenser and includes one or more motion sensing devices that include, without limitation, a gyroscope or an accelerometer. The HHC system includes a communications network capable of detecting the presence of a person with a wearable tag, preferably a Radio Frequency Identification (RFID) tag. Further, the HHC system also includes a plurality of control units, wherein each control unit is in proximity to a dispenser and includes at least the following: one or more communications devices, a feedback device in the form of a display screen, and necessary hardware to detect wearable tags and communicate with a communications network, such as a wireless computer network.

In preferred embodiments, the electronic sensor attaches to a component of the dispenser that a person must move in order to dispense a product. As an example, if the dispenser is a hand hygiene dispenser, then the sensor preferably attaches to a lever or other similar component of the dispenser that a person must move in order to dispense soap or hand sanitizer. As will be discussed in more detail below, via the one or more motion sensing devices, the sensor provides data, in the form of an electric signal, that indicates not only when the dispenser is used but also how much product (e.g. soap or hand sanitizer) was dispensed during use thereof.

In one embodiment, the sensor monitors use of a hand hygiene dispenser. In particular, the sensor monitors use of the dispenser, wherein the term “use” includes at least the following: opening an enclosure for the dispenser; closing said enclosure; or moving a lever on the dispenser to dispense a soap or hand sanitizer product. Further, although the sensor preferably attaches to a lever on the dispenser, it is understood the sensor may be attached to other components of the dispenser. Still further, the sensor receives power from and communicates with a control unit of the HHC system, wherein the control unit is mounted to a wall or similar surface in proximity to the dispenser. More specifically, the sensor includes one or more wires configured to connect to one or more General Purpose Input Output (GPIO) ports of an expansion port on the control unit. Alternatively, in a separate embodiment, the sensor includes a rechargeable power supply and a communications device such as, without limitation, a RF transceiver, wherein the sensor communicates wirelessly with the control unit, a server associated with the HHC system, or any other device on a wireless communications network.

Through the one or more motion sensing devices, the sensor collects data relating to use of the dispenser. As a non-limiting example, if the one or more motion sensing devices include an accelerometer, then the sensor, via data measured by the accelerometer, can detect when a person opens or closes an enclosure for the dispenser. Further, in response to data from the sensor indicating the enclosure has been opened or closed, use of a menu of icons displayed on the feedback device of the control unit may be enabled, wherein a person can select one or more icons to enter, communicate, or update workflow information, such as the replacement of a reservoir of soap or hand sanitizer product associated with the dispenser.

In another embodiment, one of the motion sensing devices is a gyroscope, and the sensor, via data from the gyroscope, detects not only when a person moves the lever but also how far the person moves the lever relative to its initial position. Further, a processor associated with the sensor or the HHC system compares data from the gyroscope against a predefined value (that is, an angle the lever must rotate through in order to dispense a predetermined volume of soap or hand sanitizer) and, based upon said comparison, records movement of the lever as being related to at least one of the following: a partial dispense or a full dispense. The processor may also be programmed to, based upon data from the sensor, monitor the volume of soap or hand sanitizer in a reservoir associated with the dispenser. Further, once the processor determines the volume of soap or hand sanitizer is equal to or below a predetermined amount, the processor may be programmed to alert environmental services workers via a message displayed on the feedback device of the control unit that is in proximity to the dispenser. Still further, using data collected by the control unit (i.e. identity of a person with a wearable tag that is within a predetermined proximity of the dispenser) and data from the sensor indicating use thereof, HHC scores amongst healthcare workers may be calculated based upon, among other things, how much soap or hand sanitizer product a health care worker used (i.e. how far the lever rotated) during a hand hygiene event.

In yet another embodiment, the sensor may include an orientation sensing device such as, without limitation, a magnetometer to monitor orientation (e.g. North, South, East or West) of the dispenser. As such, via the magnetometer, the sensor can detect when an enclosure for the dispenser is opened or closed based upon a change in the dispenser's orientation.

These and other embodiments of the present disclosure will become readily apparent to those skilled in the art from the following detailed description of the embodiments having reference to the attached figures, the disclosure not to be limited to any particular embodiment(s) disclosed.

### BRIEF DESCRIPTION OF THE FIGURES

FIG. 1 depicts one embodiment of a control unit associated with a HHC system

FIG. 1A depicts a front panel for the control unit shown in FIG. 1.

FIG. 1B depicts a back panel for the control unit shown in FIG. 1

FIG. 2 depicts one embodiment of an electronic sensor used to monitor use of a dispenser of hand hygiene products.

FIG. 2A shows a first location from which the sensor of FIG. 2 attaches to the dispenser of FIG. 1 to monitor use thereof.

FIG. 2B shows a second location from which the sensor of FIG. 2 attaches to the dispenser of FIG. 1 to monitor use thereof.

FIG. 3 illustrates one embodiment of a process for calibrating the sensor shown in FIG. 2.

FIG. 4 shows the lever on the dispenser shown in FIG. 1 in three separate positions, each of which can be detected by the sensor of FIG. 2.

FIG. 5 provides a graphical representation of a full dispense on a hand hygiene dispenser whose reservoir of soap or hand sanitizer product is empty or substantially empty.

FIG. 6 provides a graphical representation of a full dispense on a hand hygiene dispenser whose reservoir of soap or hand sanitizer product is full or substantially full.

FIG. 7 provides a graphical representation of a partial dispense on a hand hygiene dispenser whose reservoir of soap or hand sanitizer product is full or substantially full.

FIG. 8 provides a graphical representation of repetitive use of a dispenser whose reservoir contains no soap or hand sanitizer product.

FIG. 9 provides a graphical representation of a person opening an enclosure for the dispenser shown in FIG. 1.

FIG. 10 provides a graphical representation of a person closing the enclosure for the dispenser shown in FIG. 1.

### DESCRIPTION

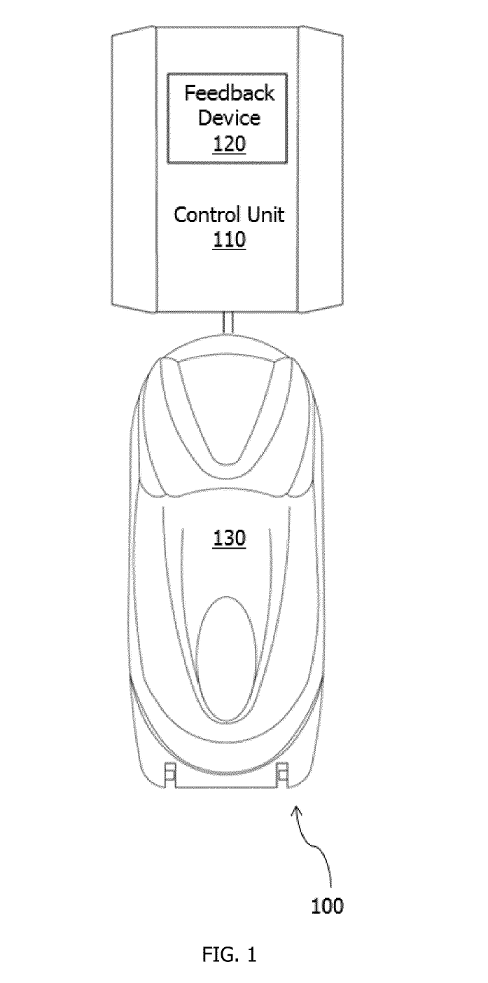

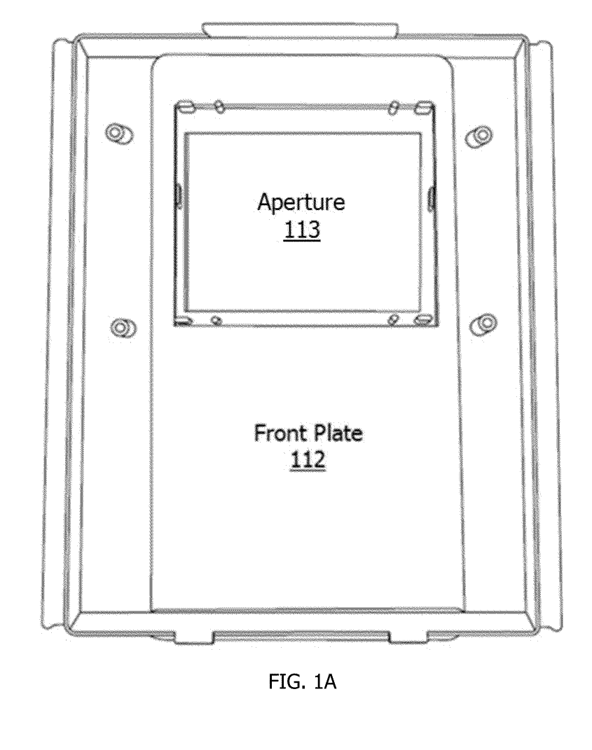

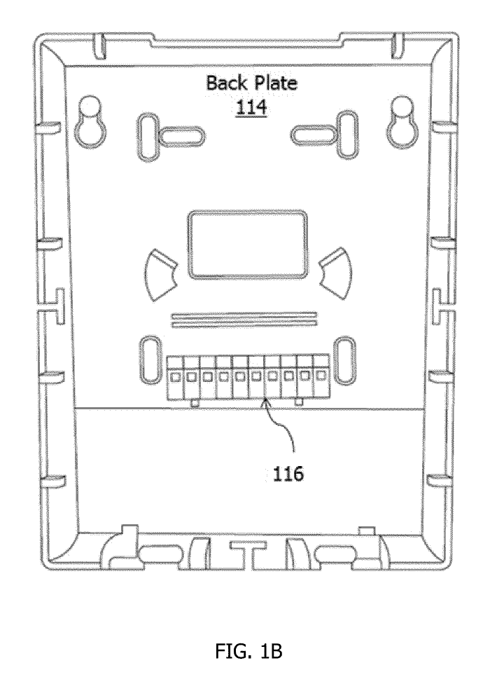

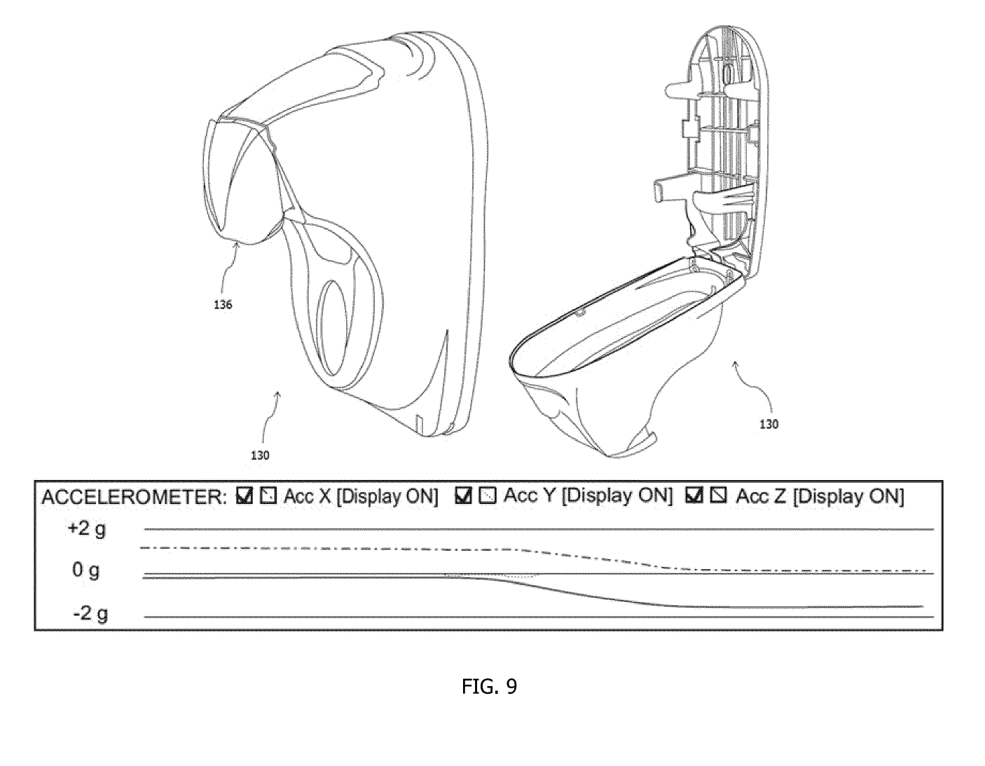

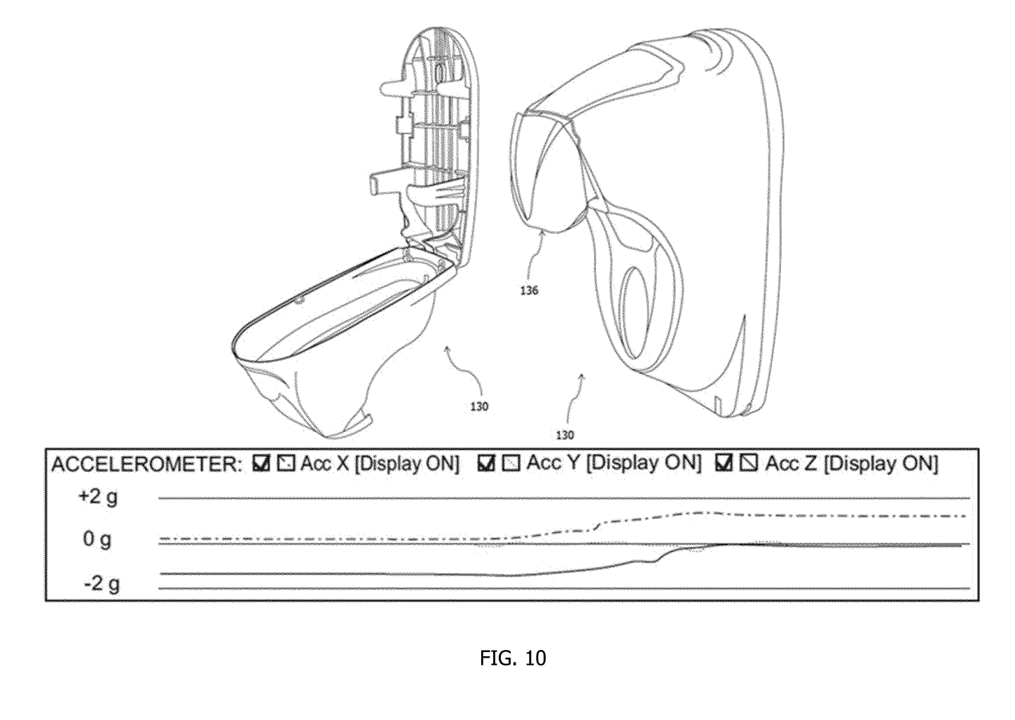

The various embodiments of the present disclosure and their advantages may be understood by referring to FIGS. 1 through 10. The elements of the drawings are not necessarily to scale, emphasis instead being placed upon illustrating the principles of preferred embodiments of the present disclosure. Throughout the drawings, like numerals are used for like and corresponding parts of the various drawings. The present disclosure may be provided in other specific forms and embodiments without departing from the essential characteristics as described herein. The embodiments described below are to be considered in all aspects as illustrative only and not restrictive in any manner.

Referring now to FIGS. 1, 1A, and 1B in combination, a control unit (110) of a HHC system (100) is shown, wherein the control unit (110) monitors individuals' proximity to a hand hygiene dispenser (130). As shown in FIGS. 1A and 1B, the control unit (110) includes a front panel (112) and a back panel (114), wherein the front panel (112) and back panel (114) create an enclosure for electronics associated with the control unit (110). More specifically, the front panel (112) includes an aperture (113) for a feedback device (120) such as, without limitation, a liquid crystal display (LCD). The back panel (114) mounts to a wall or similar vertical surface, and further includes an expansion port (116) comprising a plurality of General Purpose Input Output (GPIO) ports. Each port may be configured to provide power, a communications interface, or both. One of ordinary skill in the art having the benefit of the present disclosure should understand the term “communications interface” includes a communications link such as, but not limited to, an inter-integrated circuit (I²C) interface, a universal synchronous asynchronous receive transmit (USART) interface, a universal serial bus (USB) interface, a FireWire interface, a serial peripheral interface (SPI) interface, or any other like communications link now existing or hereinafter developed. In addition to the expansion port (116), the control unit (110) also includes one or more communications devices (not shown), wherein the one or more communications devices allow the control unit (110) to communicate with wearable tags, a server, or any other device on a wireless network associated with the HHC system.

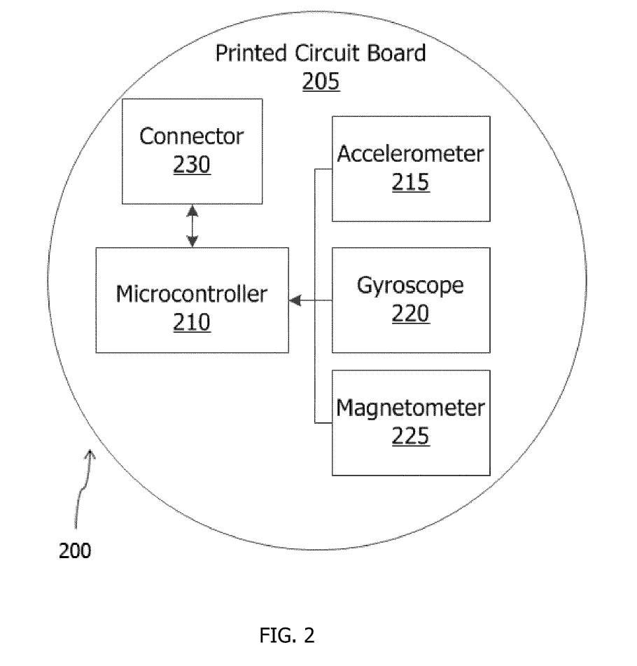

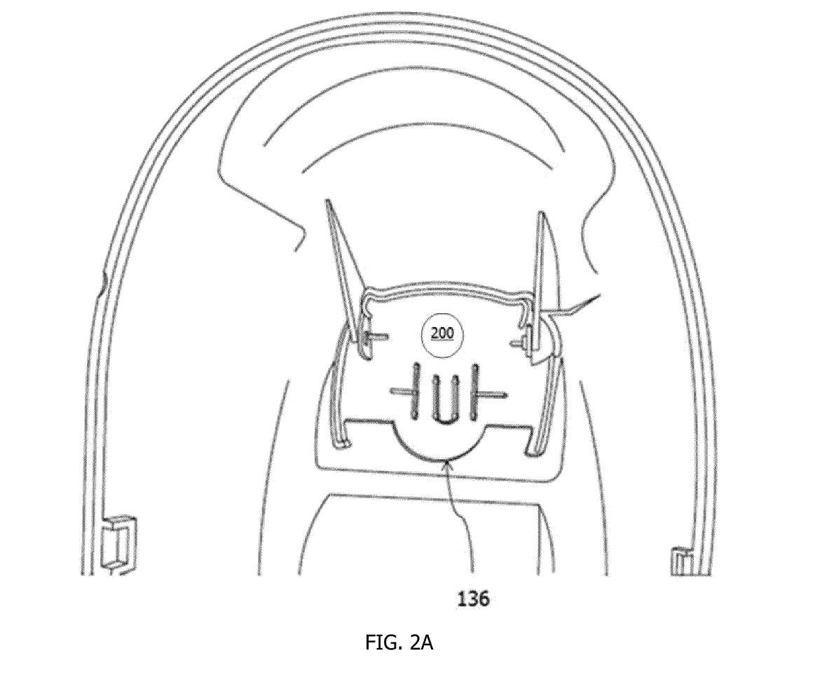

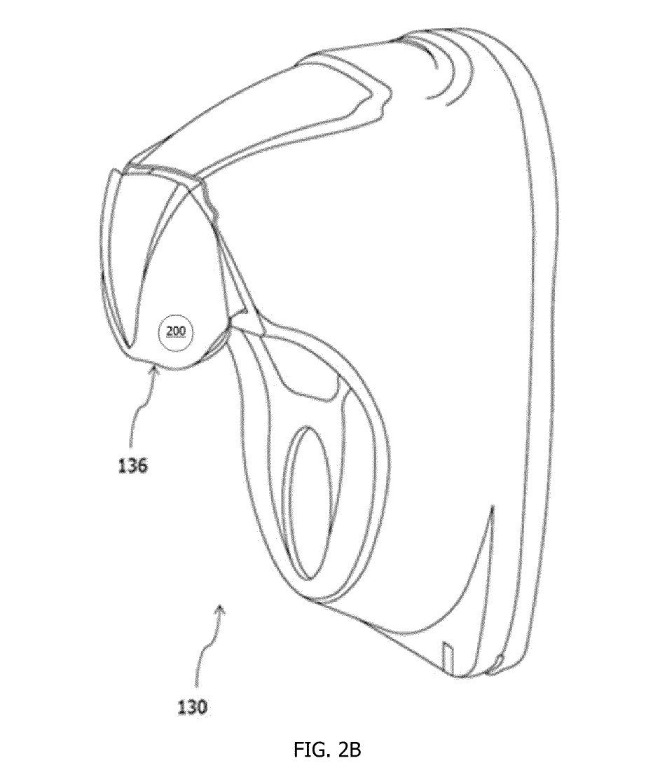

Referring now to FIG. 2, an electronic sensor (200) is shown, wherein the sensor (200) monitors use of a dispenser such as, without limitation, the hand hygiene dispenser (130) depicted in FIG. 1. More specifically, as shown in FIG. 2A, the electronic sensor (200) may be attached to the inside face of a lever (136) on the dispenser (130) and monitor use thereof via one or more motion sensing devices such as, without limitation, an accelerometer (215) or a gyroscope (220). Alternatively, as shown in FIG. 2B, the sensor (200) may be attached to other locations on the lever (136) such as, without limitation, the outside face of the lever (136). Therefore, one of ordinary skill in the art should understand the sensor (200) may be attached to a variety of different locations on the lever (136).

The sensor (200) may also include an orientation sensing device such as, without limitation, a magnetometer (225). The motion sensing device(s) as well as the orientation sensing device(s) are components on a circuit board (205) associated with the sensor (200). One of ordinary skill in the art should understand that other embodiments of the sensor (200) are within the scope of the present disclosure. For example, in a separate embodiment, the sensor (200) may monitor use of the dispenser (130) using only an accelerometer (215) and a gyroscope (220). Furthermore, although the embodiment shown in FIG. 2 depicts the accelerometer (215), gyroscope (220), and magnetometer (225) as discrete components on the circuit board (405), one of ordinary skill in the art should understand that each of these components may be consolidated into an application specific integrated circuit (ASIC).

In addition to motion and orientation sensing devices, the circuit board (205) also includes a microcontroller (210) configured to communicate with each of these devices over a communications interface such as, but not limited to, an I²C interface, a serial peripheral interface (SPI), a universal synchronous asynchronous receive transmit (USART) interface, or any other like communications interface now existing or hereinafter developed. Still further, a connector (230) on the microcontroller (210) provides an interface between the sensor (200) and the control unit (110). In particular, the sensor (200) connects to expansion port (116) via at least one wire (not shown) having a first end and a second end, wherein the first end connects to the expansion port (116) and the second end connects to a port on the connector (230). As follows, via the one or more wires, the sensor (200) receives power from the control unit (110) and communicates with the control unit (110) over a communications interface.

Alternatively, the sensor (200), namely the circuit board (205), may include its own separate power supply such as, without limitation, a lithium ion battery. The sensor (200) may also include a communications device (not shown) such as, without limitation, an RF transceiver, wherein the sensor (200) communicates with the control unit (110) or any other device (e.g., a server, a smartphone, a personal digital assistant (PDA), a tablet, a laptop or desktop computer) over a wireless network. Further, one of ordinary skill in the art should understand that the communications device may be based upon any one of the IEEE standards, such as, but not limited to, 802.11, 802.15, 802.16, or any like standard now existing or hereinafter developed.

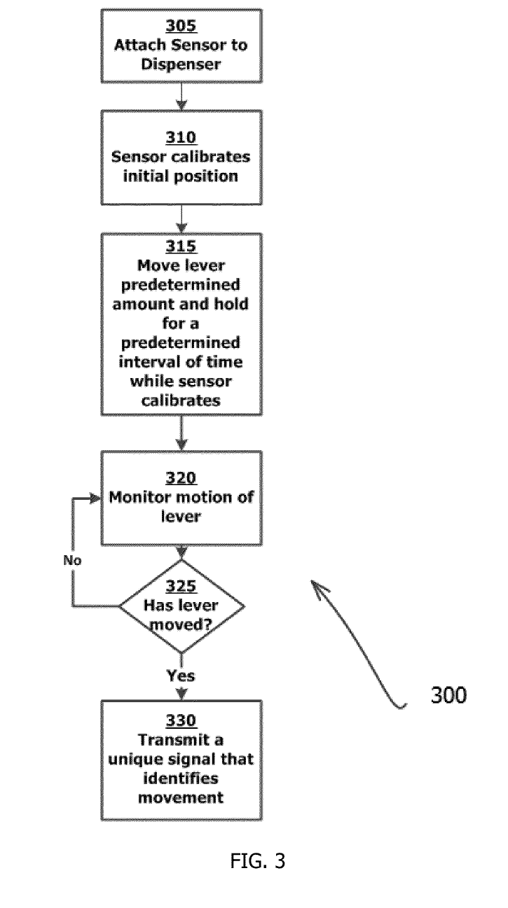

Referring now to FIGS. 1, 2 and 3 in combination, one example of a process (300) for calibrating the electronic sensor (200) is shown. The process (300) begins at step (305) when a person attaches the sensor (200) to the lever (136) on the dispenser (130). Next, at step (310), the sensor (200) calibrates its initial position (that is, the position of the lever (136) when it is not in motion). Then, at step (315), the person moves the lever (136) a predetermined amount, wherein the predetermined amount represents an angle the lever (136) must rotate through in order to dispense an optimal volume of soap or hand sanitizer product (that is, an amount sufficient to prevent the spread HAIs). As the person moves the lever (136) the predetermined amount, the gyroscope (220) detects movement thereof and measures displacement of the lever (136) relative to its initial position. Also, although not shown in FIG. 3, the gyroscope (220) communicates data to the microcontroller (210) over a communications interface, wherein data provides a benchmark to compare subsequent movement of the lever (136) against. Still further, the microcontroller (210) includes a memory unit (not shown) capable of storing information such as, without limitation, data from the gyroscope (220). After step (315), the calibration process is complete. Steps (320), (325), and (330) relate to monitoring motion of the lever (136), which is discussed in more detail below.

As an alternative to the method shown in FIG. 3, a lookup-table may be uploaded to the memory unit on the microcontroller (210) prior to installation of the sensor (200). The lookup-table may include at least the following parameters relating to the dispenser (130): a vendor (e.g. Kimberly Clark, 3M, GoJo, Ecolab, Steris, etc.), a model number for the dispenser (130), and a numerical value that represents how far a lever on the dispenser (130) must move from its initial position in order to dispense an optimal volume of soap or hand sanitizer. As follows, during installation, a person can enter the vendor and model number for a dispenser (130) by selecting one or more icons displayed on the feedback device (120) of a control unit (110) in proximity to the dispenser (130). Upon doing so, the microcontroller (210) may be programmed to associate the vendor and model number entered with the numerical value that represents how far the lever (136) on that particular dispenser (130) must move relative to its initial position in order to dispense an optimal volume of soap or hand sanitizer. Further, although in this embodiment the lookup-table is uploaded to the memory unit on the microcontroller (210), one of ordinary skill in the art should understood the lookup-table may alternatively be uploaded to a memory unit associated with the control unit (110) or a server (not shown) associated with the HHC system.

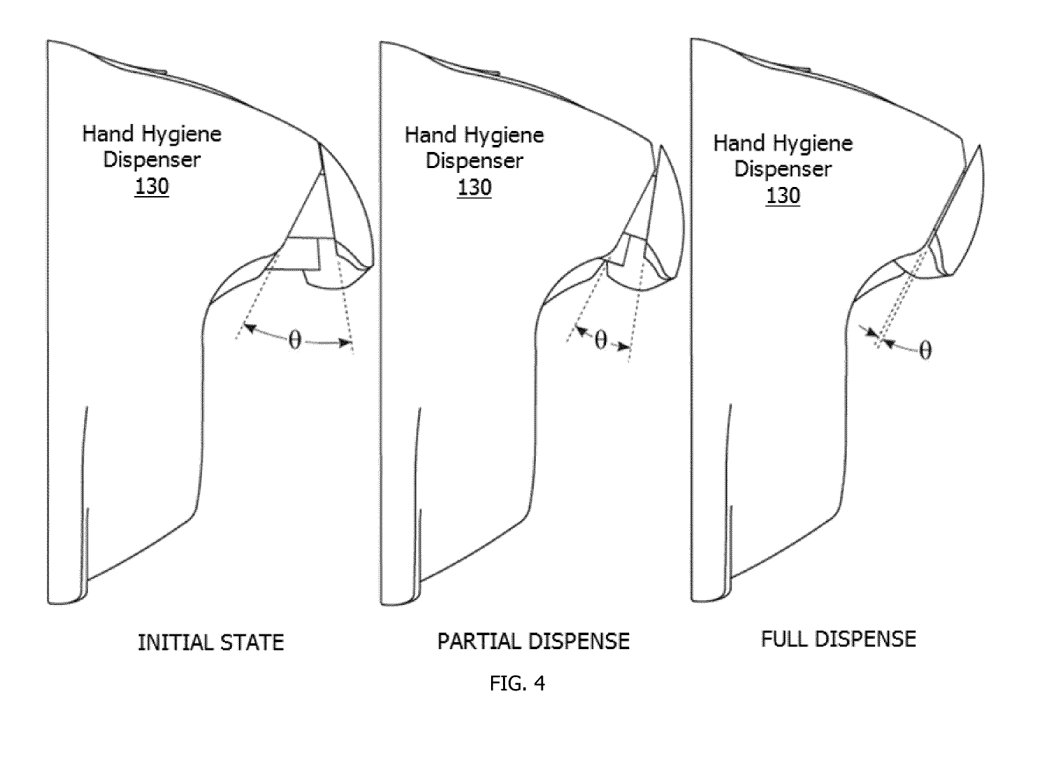

Referring now to FIGS. 2 and 4 in combination, the gyroscope (220) may be programmed to measure angular acceleration, angular velocity, angular displacement of the lever (136) relative to its initial position, or any combination of these three parameters. FIG. 4 shows the lever (136) on a hand hygiene dispenser (130) in three positions (that is, an initial position, a partial dispense, and a full dispense). As follows, using the sensor (200), and more specifically the gyroscope (220), movement of the lever (136) from the initial position to one of the other two positions (that is, a partial dispense or a full dispense) can be monitored. A “full dispense” occurs when a person moves the lever (136) a predefined amount from the initial position, wherein the predefined amount is an angle the lever must rotate through in order dispense an optimal volume of soap or hand sanitizer (that is, an amount sufficient to prevent the spread of HAIs). A “partial dispense” occurs when a person moves the lever (136) a distance from the initial position that is less than the predefined amount. As an example, if the lever (136) on a dispenser (130) must rotate through an angle of 50° in order to dispense an optimal volume of soap or hand sanitizer, then, in order to acknowledge a full dispense, the gyroscope (420) must detect motion that results in the lever (136) being temporarily displaced from its initial position by an amount equal to or greater than 50°. Otherwise, movement of the lever (136) is acknowledged as a partial dispense.

Still referring to FIGS. 2 and 4 in combination, the microcontroller (210), which as stated above is in communication with the gyroscope (220) via a communications link, may be programmed to transmit a signal to a processor (not shown) associated with the control unit (110) each time a person moves the lever (136). More specifically, the signal may be a waveform whose duty cycle varies based upon how far the lever (136) moved relative to the predefined amount that represents a full dispense. As an example, if, during use of the dispenser (130), a person displaces the lever (136) from its initial position by an amount that is equal to fifty percent (50%) of the predefined amount, then the waveform may, without limitation, be a square wave with a duty cycle of 50%. Likewise, if the person displaces the lever (136) from its initial position by an amount that is equal to seventy-five percent (75%) of the predetermined amount, then the waveform may, without limitation, be a square wave with a duty cycle of 75%. One of ordinary skill in the art should understand that the processor may also be associated with a server (not shown).

Also, since a known volume of soap or hand sanitizer is dispensed each time a full dispense occurs, the signal transmitted by the microcontroller (210) may be used to monitor volume of soap or hand sanitizer product in a reservoir associated with the dispenser (130). More specifically, if the signal represents a half-dispense, then, assuming a linear relationship between displacement of the lever (136) from its initial position and the amount of soap or hand sanitizer dispensed, the volume of soap or hand sanitizer dispensed during a half-dispense must be equal to 50% of the volume dispensed during a full dispense. Still further, assuming the relationship is non-linear, weighted values that are the result of various tests performed on the dispenser may be used to more accurately monitor the volume of soap or hand sanitizer in the reservoir. For example, if, after a series of tests, the volume of soap or hand sanitizer dispensed during a half dispense is determined to be equal to 40% of that dispensed during a full dispense, then the sensor (200) may be programmed to utilize the following formula to calculate the volume soap or hand sanitizer dispensed each time a half-dispense is detected:

Half Dispense=(0.4)*(Volume of soap/hand sanitizer dispensed during a full dispense)

As follows, the weighted value used in the formula to calculate the volume of soap or hand sanitizer dispensed during a quarter dispense must be less than 0.4. Likewise, the weighted value for a three-quarters dispense must be greater than 0.4. One of ordinary skill in the art should understand that these weighted values vary amongst dispensers due to a plurality of factors related to, amongst other things, the design of a dispenser.

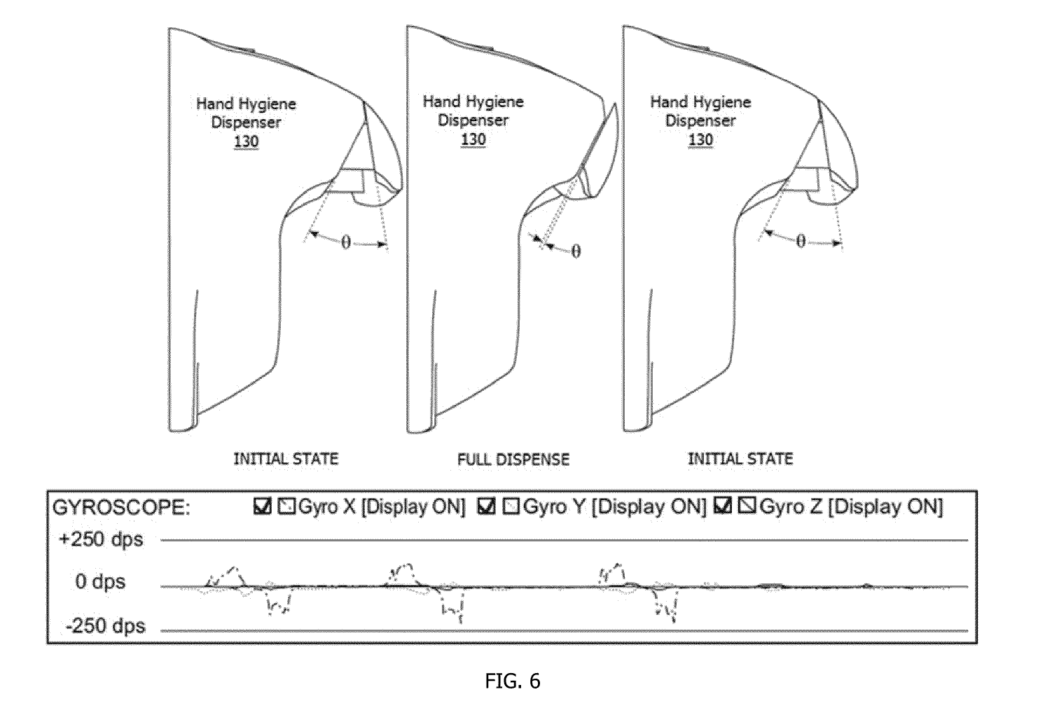

Further, the signal from the microcontroller (210) may be used by the control unit (110) or a server (not shown) associated with the HHC system (100) to calculate hand hygiene compliance scores amongst healthcare workers. In particular, HHC scores may be calculated based upon how far the lever (136) moved during a hand hygiene event (that is, when a person moves the lever (136) to dispense soap or hand sanitizer). As an example, if the signal from the microcontroller (210) represents a partial dispense, then the healthcare worker credited for the hand hygiene event may receive a score that is commensurate with a partial dispense. In other words, if a full dispense receives a score of 5.0, then a partial dispense may receive a 2.5. One of ordinary skill in the art should understand that the two states (i.e. full dispense and partial dispense) shown in FIG. 6 are for illustrative purposes only, and should further understand that movement of the lever (136) may be subdivided into a plurality of states. For example, as discussed above, a partial dispense can be further defined as one of the following: a quarter dispense, a half dispense, or a three-fourths dispense.

Still further, upon detecting use of a dispenser (130), a score calculated based upon the signal from the microcontroller (210) may be displayed on a feedback device (120) associated with a control unit (110) that is in proximity to the dispenser (130). In addition, the control unit (110) may be programmed to communicate at least the following information to a server: 1) identity of the healthcare worker (that is, a unique identification code associated with a wearable tag worn by the healthcare worker); 2) data from the sensor (200); and 3) a location identifier associated with the control unit (110). Information may also be published on an intranet website or other media that may be accessed by authorized users, such as a nurse manager or hospital administrator, to monitor compliance scores for one or more healthcare workers. As follows, using the published information, nurse managers and hospital administrators can more accurately monitor healthcare workers' compliance with hand hygiene protocols.

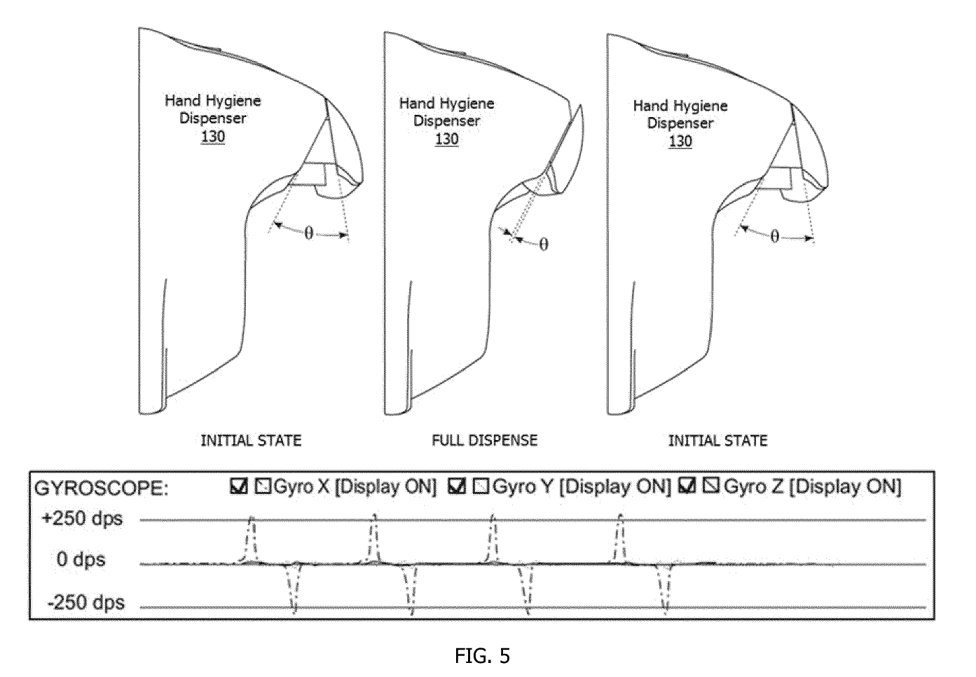

Referring now to FIGS. 5 and 6 in combination, each of these figures illustrate the effect the reservoir has on data collected by the gyroscope (220). FIG. 5 depicts an analog signal that represents a full dispense on a dispenser (130) whose reservoir is empty or substantially empty. Conversely, FIG. 6 depicts an analog signal that represents a full dispense on a dispenser (130) whose reservoir is full or substantially full. The amplitude of angular velocity measurements associated with the analog signal in FIG. 5 is greater than those associated with the analog signal shown in FIG. 6. Also, the analog signal shown in FIG. 6 includes electric noise in the form of a vibration that is caused by the reservoir. More specifically, since the reservoir is full or substantially full, the reservoir opposes motion of the lever (136) more so than it would if the reservoir was empty or nearly empty. As follows, the lever (136) rotates at a lower angular velocity when the reservoir is full or substantially full.

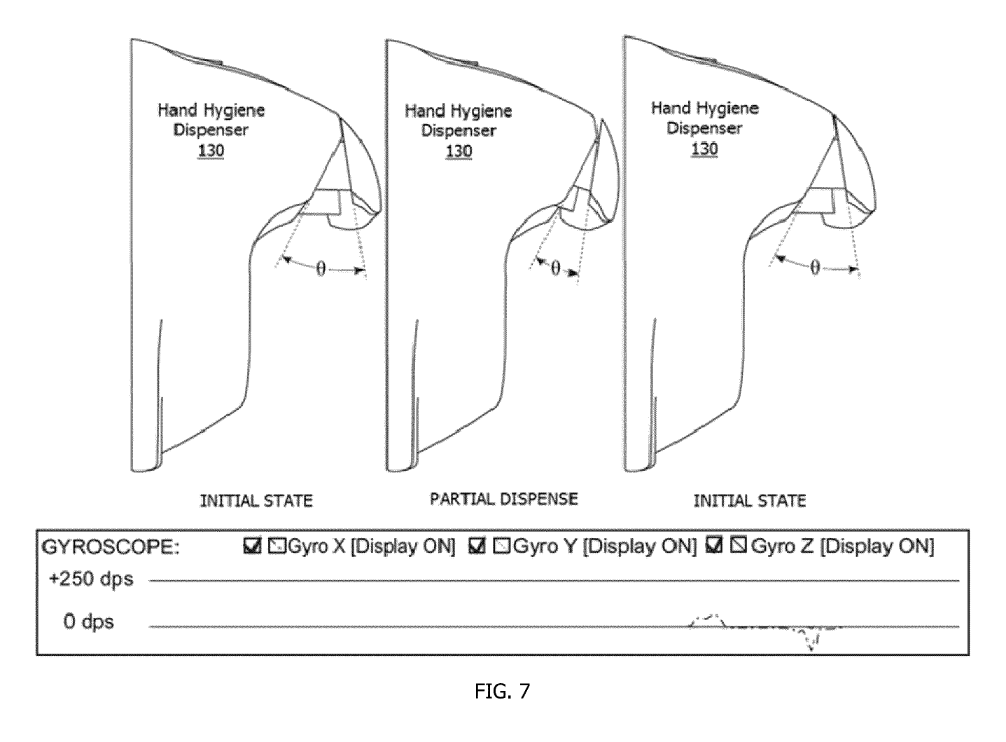

FIG. 7 depicts an analog signal that represents a partial dispense on a hand hygiene dispenser (130) whose reservoir is full or substantially full. Similar to FIG. 6, the reservoir has an effect on angular velocity measurements generated by the gyroscope (220). Thus, software running on a processor associated with the sensor (200), the control unit (110), or a server associated with the HHC system (100) may include algorithms that allow the processor to determine whether the reservoir is empty or substantially empty based upon an upward trend in the amplitude of angular velocity measurements for the lever (136) over a predefined number of hand hygiene events. Further, by displaying a message on the feedback device (120) of a control unit (110) in proximity to the dispenser (130), the processor can prompt an environmental services worker to either replace the reservoir or replenish its supply of soap or hand sanitizer product. Still further, the processor may also be programmed to alert environmental services via a variety of communication methods that well-known within the prior art, such as e-mail, text messages, or an automated voice message sent to a cellular device (e.g. smartphone) associated each of the workers.

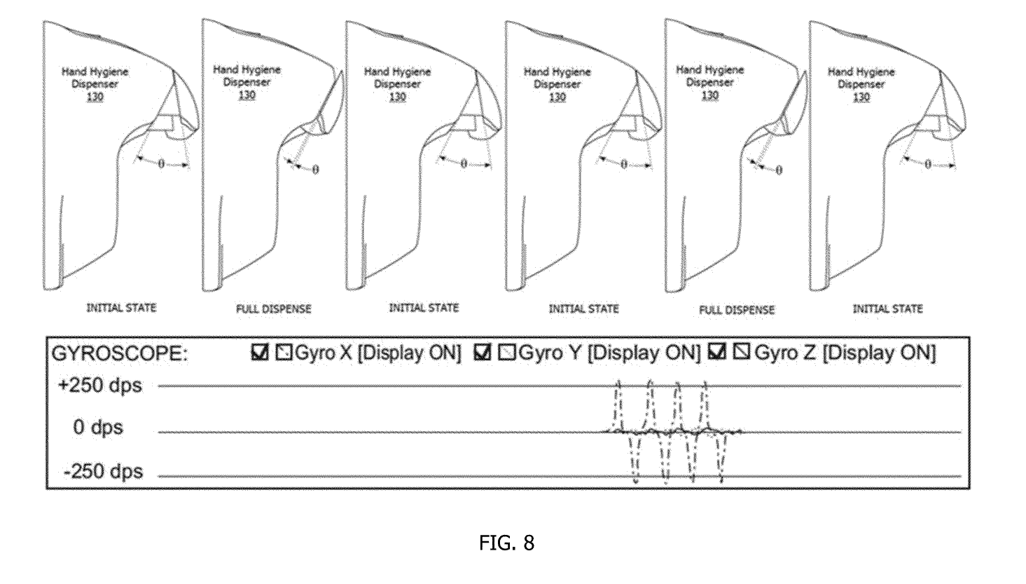

FIG. 8 provides a graphical representation of data from the gyroscope (420) that depicts a series of full dispenses on a hand hygiene dispenser (130) whose reservoir of soap or hand sanitizer is empty or substantially empty. This data may be used by the processor to determine the reservoir needs to be replaced. More specifically, software running on the processor may include algorithms capable of detecting an empty reservoir or dysfunctional dispenser (130) each time the processor receives an analog signal, wherein the amplitude of angular velocity measurements associated with the signal are substantially similar to those depicted in FIG. 5. Further, upon determining the reservoir is empty or the dispenser (130) has malfunctioned, the processor may be programmed to alert environmental services via any one of the communication methods referenced above.

Referring now to FIGS. 2, 9 and 10 in combination, the accelerometer (215) may be used to measure acceleration forces acting on the dispenser (130) such as, without limitation, acceleration forces caused by a person opening or closing an enclosure for the dispenser (130). The microcontroller (210), upon receiving data from the accelerometer (215), may be configured to communicate data to a processor programmed to determine, based upon data, whether a person has opened or closed the enclosure. Alternatively, the microcontroller (210) may be configured to execute software that allows the microcontroller (210) to determine, based upon acceleration data, that a person has opened or closed the enclosure. Regardless, once the microcontroller (210) or the processor determines, based upon data, that the enclosure has been opened or closed, then a control unit (110) in proximity to the dispenser (130) enables use of a menu of icons displayed on the feedback device (120). As follows, a person can select one or more icons on the menu to communicate, enter, obtain, or update workflow information such as, whether a reservoir associated with the dispenser has been replaced or replenished.

The use of the terms “a” and “an” and “the” and similar referents in the context of describing the present disclosure (especially in the context of the following claims) are to be construed to cover both the singular and the plural, unless otherwise indicated herein or clearly contradicted by the context. The use of any and all examples, or exemplary language (e.g., “such as”) provided herein, is intended merely to better illuminate the present disclosure and does not pose a limitation on the scope of the disclosure unless otherwise claimed. Also, no language in the specification should be construed as indicating any non-claimed element as essential to practicing the present disclosure.

Further, one of ordinary skill in the art will recognize that a variety of approaches for communicating workflow information with a HHC system may be employed without departing from the teachings of the present disclosure. Therefore, the foregoing description is considered in all respects to be illustrative and not restrictive

1. A method for using an electronic sensor of a hand hygiene compliance system to monitor compliance with hand hygiene protocols, the method comprising:
identifying a person within a predetermined proximity of a control unit associated with a hand hygiene dispenser, the person wearing a wearable tag configured to be detectable by a communications device of the control unit;
detecting movement of a lever on the hand hygiene dispenser, the electronic sensor attached to the lever and configured to detect a movement of the lever from an initial position that occurs when the person presses the lever in order to cause the hand hygiene dispenser to dispense a hand hygiene product;
determining a volume of hand hygiene product dispensed by the hand hygiene dispenser, the hand hygiene compliance system configured to determine the volume of hand hygiene product dispensed based on the movement of the lever from the initial position; and
generating a hand hygiene score for the person based on the volume of hand hygiene product dispensed, the hand hygiene score stored on a server associated with the hand hygiene compliance system.

2. The method of claim 1, further comprising publishing a hand hygiene report on an intranet website, the hand hygiene report comprising the hand hygiene score for the person.

3. The method of claim 1, wherein use of the intranet website is limited to authorized users.

4. The method of claim 1, wherein the movement of the lever from the initial position represents a full dispense.

5. The method of claim 1, wherein the movement of the lever from the initial position represents a partial dispense.

6. The method of claim 1, further comprising displaying the hand hygiene score on a feedback device associated with the control unit.

7. The method of claim 1, wherein the detecting step is performed by a motion sensing device of the electronic sensor.

8. The method of claim 7, wherein the motion sensing device is a gyroscope operable to measure angular velocity of the lever each time the person presses the lever.

9. The method of claim 7, wherein the motion sensing device is an accelerometer operable to measure gravitational forces acting on the lever.

10. The method of claim 1, further comprising decrementing a measurement of hand hygiene product in the dispenser by an amount equal to the volume of hand hygiene produce dispensed as a result of the movement of the lever from the initial position.

11. The method of claim 10, further comprising communicating a message when the measurement of hand hygiene product in the dispenser reaches a predetermined volume.

12. The method of claim 11, wherein the message is an electronic message sent to an environmental services department of facility in which the hand hygiene compliance system is located.

13. A hand hygiene compliance system for monitoring compliance with hand hygiene protocols, the system comprising:
a control unit associated with a hand hygiene dispenser, the control unit further comprising a communications device operable to detect a wearable tag worn by a person that is within a predetermined proximity of the hand hygiene dispenser;
an electronic sensor attached to a lever on the hand hygiene dispenser, the electronic sensor in communication with the control unit and operable to detect a movement of the lever that occurs when the person uses the hand hygiene dispenser;
a processor to determine volume of hand hygiene product dispensed due to the movement of the lever; and
a feedback device to display a hand hygiene score for the person, the hand hygiene score based at least in part on the movement of the lever that is detected by the electronic sensor.

14. The method of claim 13, wherein the feedback device is a component of the control unit.

15. The method of claim 13, wherein the processor is a component of the electronic sensor.
